(19) United States
(12) Patent Application Publication
(10) Pub. No.: US 2002/0087857 A1
(43) Pub. Date: Jul. 4, 2002

(54) Security system for high level transactions between devices

(76) Inventors: Victor Y. Tsao, Park City, UT (US); John Xidos, Sydncy (CA)

Correspondence Address: WILSON SONSINI GOODRICH & ROSATI, 650 PAGE MILL ROAD, PALO ALTO, CA, 943041050

(21) Appl. No.: 09/854,415

(22) Filed: May 10, 2001

Related U.S. Application Data
(60) Provisional application No. 60/203,277, filed on May 10, 2000.

(51) Int. Cl. H04L 9/00; H04K 1/00; G06F 17/60

(52) U.S. Cl. 713/155; 380/251; 705/55

(57) ABSTRACT

The invention provides a security system and methods for high level transactions between devices. The system includes a non-deterministic hardware random number generator to provide multi-level encryption between a remote and host device.

### FIELD OF THE INVENTION

The invention provides a security system and methods for high level transactions between devices. The system includes a non-deterministic hardware random number generator to provide multi-level encryption between a remote and host device.

### BACKGROUND OF THE INVENTION

In the growing world of Internet and electronic transactions, transaction security is of prime concern to all parties involved in the transaction. This security is required in order to minimize the risk of an unwanted third party obtaining information about the transaction and/or obtaining information enabling subsequent access to a particular device or system. In today's busy electronic world, transaction security is required for all types of transactions, including transactions between individuals, between individuals and businesses/organizations as well as between businesses or organizations. In addition, in certain industries, it is also a requirement that particular transactions be selectively monitored by third-party regulatory and/or licensing agencies which may also require sophisticated levels of security.

Within the realm of secure transactions, the use of encryption/decryption technology is well known. That is, it is well known that data sent between different parties can be encrypted and subsequently decrypted by the second party upon receipt using various methods including encryption/decryption keys. Typically, the encryption/decryption keys are algorithm based or pseudo random (deterministic) and thus, are limited in that they have repeating patterns with a finite cycle size. A skilled programmer can within hours or even minutes create a mathematical model of such a pseudo-random number generator and thereby breach the security of a device. The ability to crack a security system can often be accomplished either with or without inside information about security protocols.

In comparison, a non-deterministic random number generator is inherently more secure as the risk of predicting an outcome or affecting an outcome is more difficult. Such non-deterninistic or hardware based random number generators (RNG) have been subjected to various statistical random number generator tests, for example, those specified in the Federal Information Processing Standard (FIPS) Publication 140-1 by the InfoGard Laboratories (an accredited cryptographic test laboratory by the US Commerce Department's National Institutes of Standards Technology (NIST), the Canadian Government's Communication Security Establishment (CSE) and by the NVLAP, a cryptographic modules testing laboratory (Accreditation number 100432-0) and have been verified as providing non-deterministic outcomes.

A hardware RNG (HRNG) produces truly random bits based on naturally occurring random phenomena. An example is the Johnson or white noise generated from a micron sized heat dissipating ceramic resistor. Amplification of the noise, AID conversion and digital processing enables the creation of a random stream of bits with an infinite cycle size. The randomness is truly random in that it is a function of the thermal noise due to the random motion of electrons within the heated resistor ensuring a wideband noise source with equal noise densities at all frequencies. Current hardware RNGs do not require a starting value or seed and can operate at speeds generally no less than 20 kbits/sec and generally limited only by the speed of the system.

At the present time, sensitive transactions between devices are provided by both hardware and software solutions to provide high security levels. These devices include cell phones, network equipment, cable modems, set-top boxes, network computers, satellite receivers, palm-top computers and gaming machines. As high-value content movies, games, financial information, electronic commerce, corporate information, confidential email and voice communications migrate to these devices, robust data security is continuing to emerge as a requirement for all classes of platforms.

More specifically, the gaming industry requires an extremely high level of security to ensure that the integrity of the machines supporting a game-of-chance is maintained. Gaming regulators, in order to grant gaming licenses, must be satisfied with the integrity of individual gaming machines to ensure fairness in the game and to prevent any unauthorized attack which may determine the outcome of the game. At the present time, the random number generators within a gaming device are software based, inherently deterministic, and therefore vulnerable to attack by sophisticated hackers.

In the software industry, the use of dongles (a hardware and software security device) is widespread. Dongles are used to ensure that a particular copy of licensed software is utilized strictly on a specific machine by a single user at any particular time in order to prevent unauthorized use of software outside a license agreement. Existing dongles typically connect to an I/O port of the devices and operate to provide a validation code when periodically queried by a host program. If the code is not provided, the host program is terminated.

In the financial transaction industry, the exchange of financial and other data, requires high levels of security often using software based encryption/decryption systems during transactions.

In view of the requirements for transaction integrity, there has been a need for a system providing increased levels of security in electronic transactions between different devices. In particular, there has been a need for a security system enabling the generation of non-deterministic hardware based random numbers for the creation of encryption/decryption keys between devices to reduce the potential for unauthorized attack from third parties. In particular there has been a need for protection against designers and developers who may possess privileged information.

In addition, within such security systems, there has been a need for increased intelligence to enable enhancement of the functionality of an existing host device with the increased security features of a non-deterministic random number generator.

Still further, with the increasing demand for transaction security from a host of different devices, there has been a need for systems which can be readily retrofit to existing devices and which do not otherwise interfere with the regular operation of the device and its associated peripherals. It is also required that a security system appears transparent to the regular operation of the device in order to impose minimal performance penalties on the main function of the system.

Still further, with the increasing use of passwords, PINs, cards and tokens to access remote accounts, there is an increasing security risk associated with a user possessing and managing many different security devices. Accordingly, there has been a need for advanced user identification systems including biometric identification systems, including electronic finger printing and voice and facial recognition systems to be coupled with other security systems.

### SUMMARY OF THE INVENTION

In accordance with the invention, there is provided a system for securing data transactions between a remote and host device, the remote device comprising:

an interface adapted for operative connection between the host device and the remote device;

a managing controller operatively connected to the interface, the managing controller for controlling data transactions between the remote and host device; and,

a hardware random number generator (HRNG) controller operatively connected to the managing controller for providing non-deterministic random number data for data encryption to the managing controller.

In accordance with a further embodiment, the invention provides a system for controlling and managing data communications between a host device and the remote device, comprising:

an interface adapted for operative connection between the host device and the remote device;

a managing controller operatively connected to the interface, the managing controller for receiving and providing data to and from the host device and for receiving and providing data to and from a hardware random number generator controller operatively connected to the managing controller, the HRNG controller for providing non-deterministic random number data to the managing controller.

In accordance with a still further embodiment, the invention provides a method of enrolling a specific remote device with a host device comprising the steps of:

a. generating and storing a non-deterministic ID number in the remote device;

b. encrypting the ID number to a first level with a non-deterministic ID decrypt key;

c. encrypting the first level encrypted ID number to a second level with a public key;

d. passing the second level encrypted ID number to the host device;

e. decrypting the second level encrypted ID number in the host device with the public key to the first level and storing the first level encrypted ID number in the host device.

In a still further embodiment, the invention provides a method of verifying the enrollment of a specific remote device with a host device comprising the steps of:

a. requesting a first level encrypted non-deterministic ID number from the host device by the remote device;

b. receiving and decrypting the first level encrypted non-deterministic ID number with a previously generated and stored non-deterministic ID decrypt key; and,

c. verifying equivalency between the decrypted non-deterministic ID number of step d. with a previously generated and stored non-deterministic ID number in the remote device.

In a still further embodiment, the invention provides a method of transferring data between a remote device previously enrolled with a host device comprising the steps of:

a) encrypting a data packet with a non-deterministic data decrypt key;

b) encrypting an ID number with a non-deterministic ID decrypt key;

c) appending the encrypted data packet of step a) to the encrypted ID number of step b) with the ID decrypt key of step b) to form an encrypted data packet;

d) encrypting the encrypted data packet of step c) with a public key to form a second level encrypted data packet;

e) passing the second level encrypted data packet to the host device; and,

f) decrypting the second level encrypted data packet of step e) with the public key and data decrypt key to retrieve the data packet.

The invention may also provide a biometric identification system for specific user identification with a remote and host device.

In a further still embodiment, a system is provided for enrolling a user with a service provider to allow access to the service provider from a non-secure location comprising the steps of:

at a secure or non-secure location for enrolling the user,

a) providing a user with a character personal identification number (PIN);

b) providing a user with a voice PIN;

c) having a user speak the voice PIN into a voiceprint processor to create a secure-location voice print file of the voice PIN;

d) storing the character PIN and voice print file in an authorized user database.

Further still the invention provides a system wherein at a non-secure location having a computer and a second voice print processor operatively connected to the authorized user database, a method of:

a) prompting a user to enter the character PIN;

b) prompting a user to enter the voice PIN into the second voice print processor to create a non-secure location voice print file;

c) submitting the character PIN and non-secure location voice print file to the authorized user database; and,

at the authorized user database

d) searching the character PIN in the authorized user database for similar character PINs; and

e) searching the non-secure location voice print file against the voice print files of record for similar character PINs to determine if the non-secure location voice print file corresponds to a voice print file of record.

In a further still embodiment, a method is provided for enrolling and securing transactions between host devices each having a dongle and a central enrollment database comprising the steps of:

a) enrolling an encrypted ID# within the dongle with the central enrollment database; and,

b) verifying each host device has completed the enrollment of step a) prior to permitting a public key encrypted transaction between the host devices.

### BRIEF DESCRIPTION OF THE DRAWINGS

These and other features of the invention will be more apparent from the following description in which reference is made to the appended drawings wherein:

FIG. 1 is an overview of the security system in accordance with the invention;

FIG. 2 is an overview of the hardware random number based remote device in accordance with one embodiment of the invention;

FIG. 3 is an overview of the security protocol in accordance with one embodiment of the invention;

FIG. 3a is an overview of a two-part ID# in accordance with one embodiment of the invention;

FIG. 3a is an overview of a two-part ID# sent with data in accordance with one embodiment of the invention;

FIG. 4 is a schematic diagram of a parallel port specific dongle in accordance with one embodiment of the invention;

FIG. 5 is a circuit diagram of a serial port specific dongle with biometric voice ID in accordance with one embodiment of the invention; and,

FIG. 6 is a schematic diagram of a enrolling and authorizing users with a service provider having a biometric identification system in accordance with one embodiment of the invention;

FIG. 7 is a schematic diagram of the security system having a card reader; and,

FIG. 8 is a schematic diagram of a security system for enrolling remote devices with a central site and authenticating a transaction.

### DETAILED DESCRIPTION OF THE INVENTION

General Description of the Invention

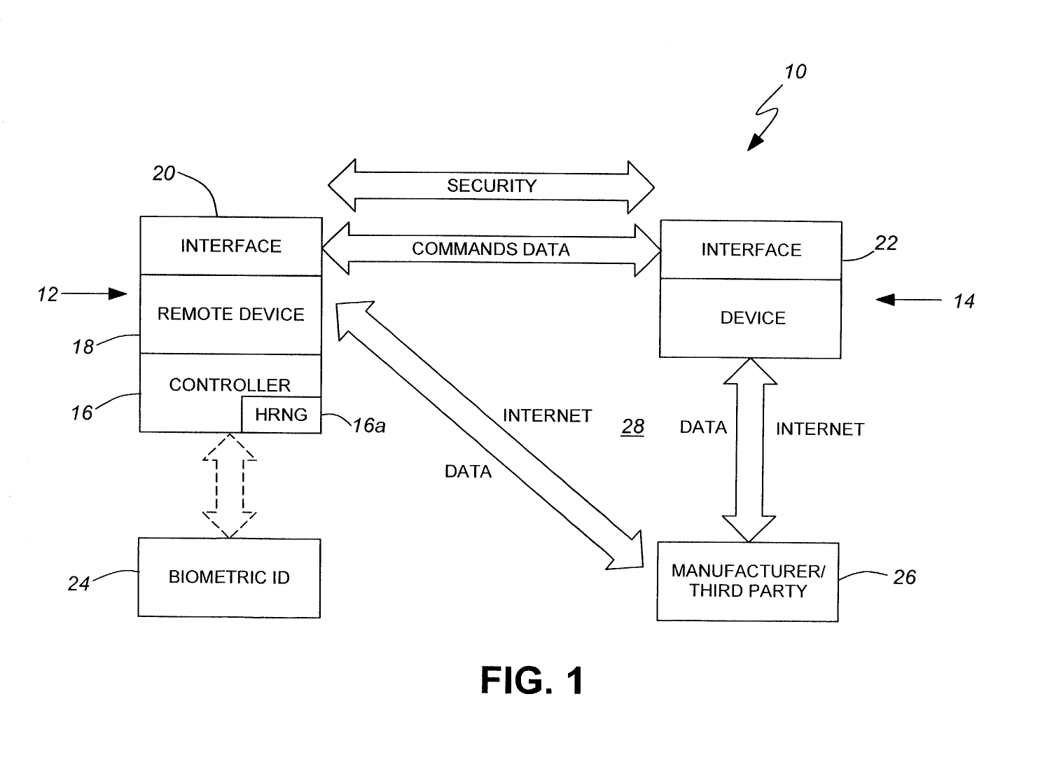

In accordance with the invention, and with reference to FIG. 1, a security system 10 is provided enabling secure data transactions between electronic devices and specifically a remote device 12 and local device 14 (host). The remote device 12 includes a hardware random number generator (HRNG) controller 16 with a HRNG 16a, operatively connected to a managing microcontroller 18 and an interface 20. The remote device 12 communicates with the local device 14 via a wired or wireless link to exchange data between the devices or to provide one-way command data to the local device 14 between respective interfaces 20, 22. In various embodiments of the invention, the remote device 12 may include biometric ID functionality 24. Both the remote device 12 and the local device 14 may communicate with a manufacturer or third party 26 via network links 28 such as the Internet to send and receive data between respective devices.

The HRNG 16 of the remote device establishes and manages the security between the remote device 12 and the local device thereby enabling high security data transactions between the remote device 12 and local device 14. A non-exhaustive list of examples of remote and local devices and their basic functions are listed in Table 1.

TABLE 1
Examples of Remote/Local Devices

| | Remote Device | | Local | Local Device |
|---|---|---|---|---|
| Remote Device | Functions | Interface | Device | Functions |
| Dongle for | HRNG security | pass-through | Gaming | gaming to |
| Gaming | HRNG | interface (eg. | Device | user |
| Industry | formatted | serial or | (VLT) | |
| | gaming data | parallel) | | |
| Dongle for | HRNG security | pass-through | Financial | Account |
| point-to-point/ | | interface (eg. | Services | Management |
| Internet | | serial or | (eg. Bank | Financial |
| transactions | | parallel) | server) | transactions |
| Remote | HRNG security | wired or | consumer | execute |
| Control | command data | wireless | products | remote |
| Device | | | (eg. car, | command |
| | | | home | data |
| | | | appli- | |
| | | | ances) | |

Overview of Remote Device Hardware Operation

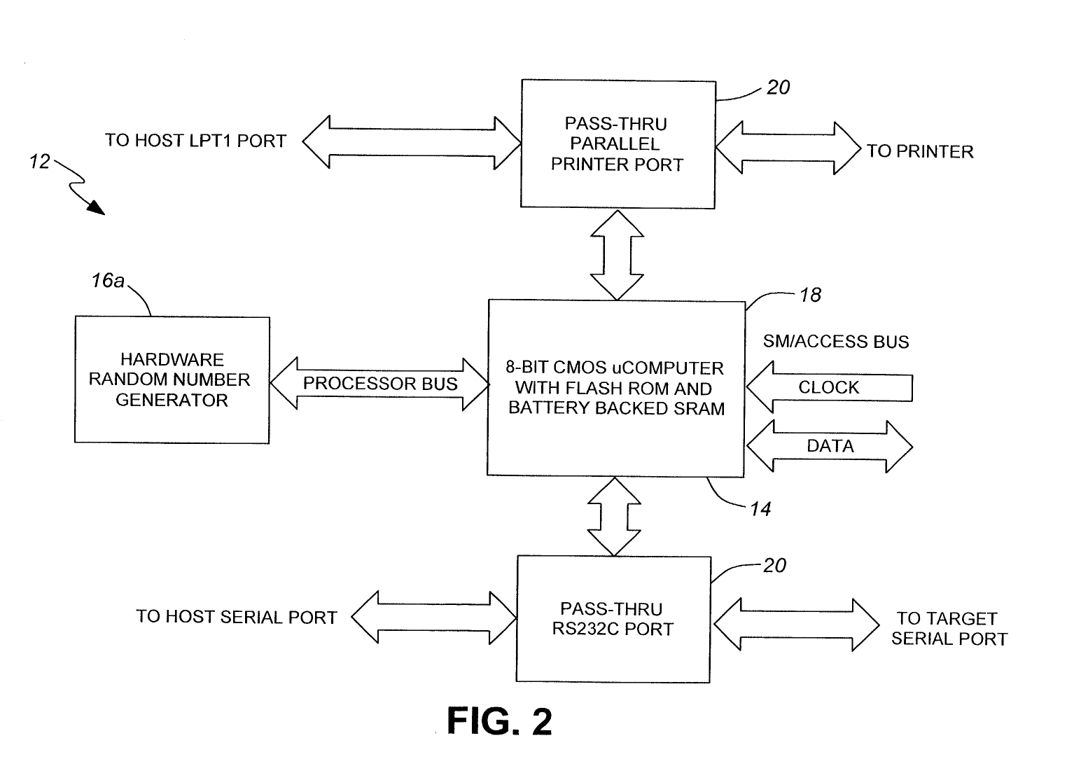

With reference to FIGS. 1 and 2, in each embodiment of the remote device 12, the remote device includes an HRNG controller 16 operatively connected to a managing microcontroller 18 and interface 20.

The managing controller 18 generally provides a physical and hard security wall between the HRNG controller 16 and the local device 14 as well as managing all private communications with the HRNG controller 16.

The HRNG controller 16 includes a hardware random number generator (HRNG) 16a which produces non-deterministic streaming random number bits. The HRNG controller 16 captures the random number bit stream from the HRNG 16a and formats the stream into application sensitive bytes (if required) or into a context for encrypting data. In addition, the managing controller 18 manages the secured (encrypted) communication between the HRNG controller 16 and the host 14.

Overview of Communication Protocol Between Remote Device and Local Device

Communication between the remote and local devices requires an initialization between the remote and local devices prior to a data transaction. Initialization is controlled by the remote device.

After initialization between the remote and local device, further communication between the remote and local devices may be initiated by the local device in certain applications or alternatively may only be initiated by the remote device.

As will be explained in greater detail below, the HRNG controller 16 contains a secured memory area that contains special ID functions that can be only be installed at the factory. This area of the memory cannot be reverse engineered and includes various tamper detection mechanisms which will prevent any unauthorized access to this memory area.

The HRNG controller 16 random encryption functionality produces a public key and passes it onto the host-device only during initialization, then passes a two-part I.D. number with an encrypted part and a permanently assigned legible part. The legible part is assigned by the manufacturer or by a third party such as a monitoring jurisdiction. The encrypted part is created randomly by the HRNG and permanently assigned to a specific remote device and stored within the HRNG controller's secured memory area. The two-part ID number is then sent to the host-device encrypted with a public key. The HRNG controller 16 will subsequently change the public key for each transaction between the remote and host-device. This random relationship is known only to the HRNG controller and to no others and, accordingly, the remote device, once enrolled into service by a host-device, will only work with that host-device. The encrypted part of the I.D. number is only known to the HRNG controller, because it is created by it own Artificial Intelligence (Al) enveloped by a changing random public key. As the encrypted part of the ID number is only known by the HRNG controller in a secured memory area, this method prevents those individuals with inside information from hacking in.

Communication Protocol between the Remote and Host Devices

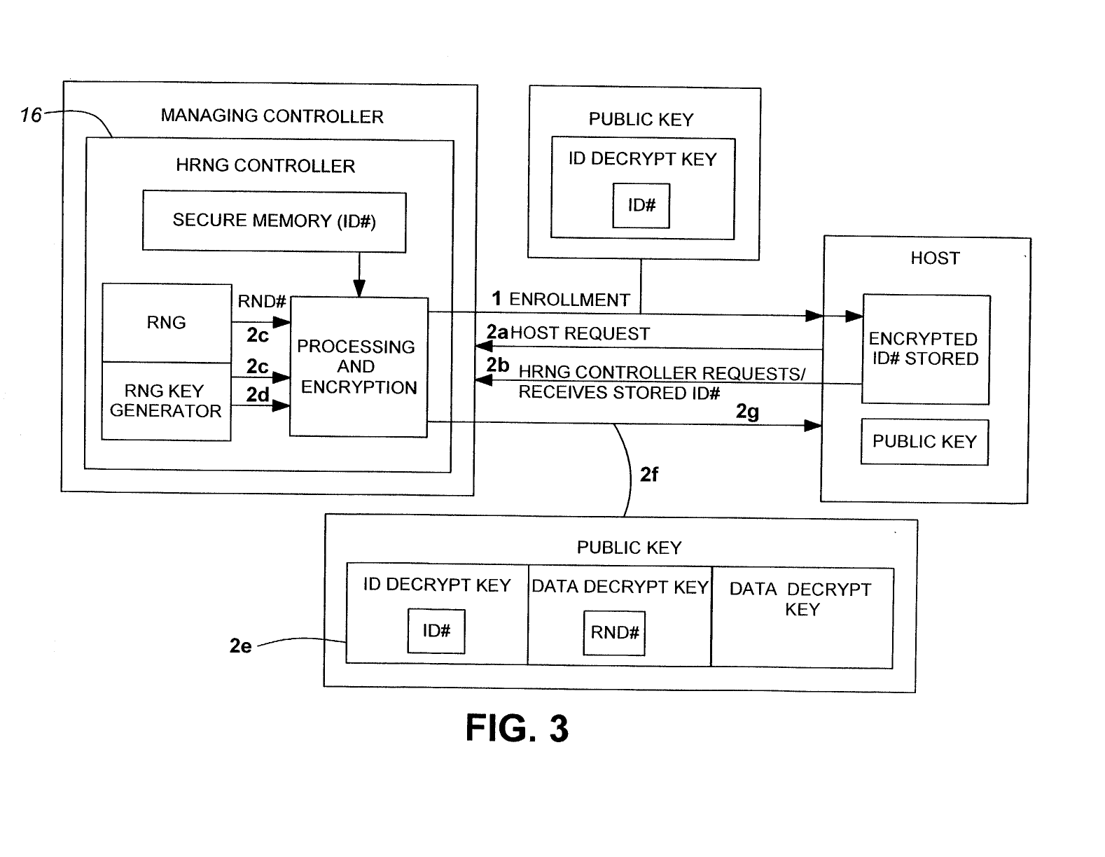

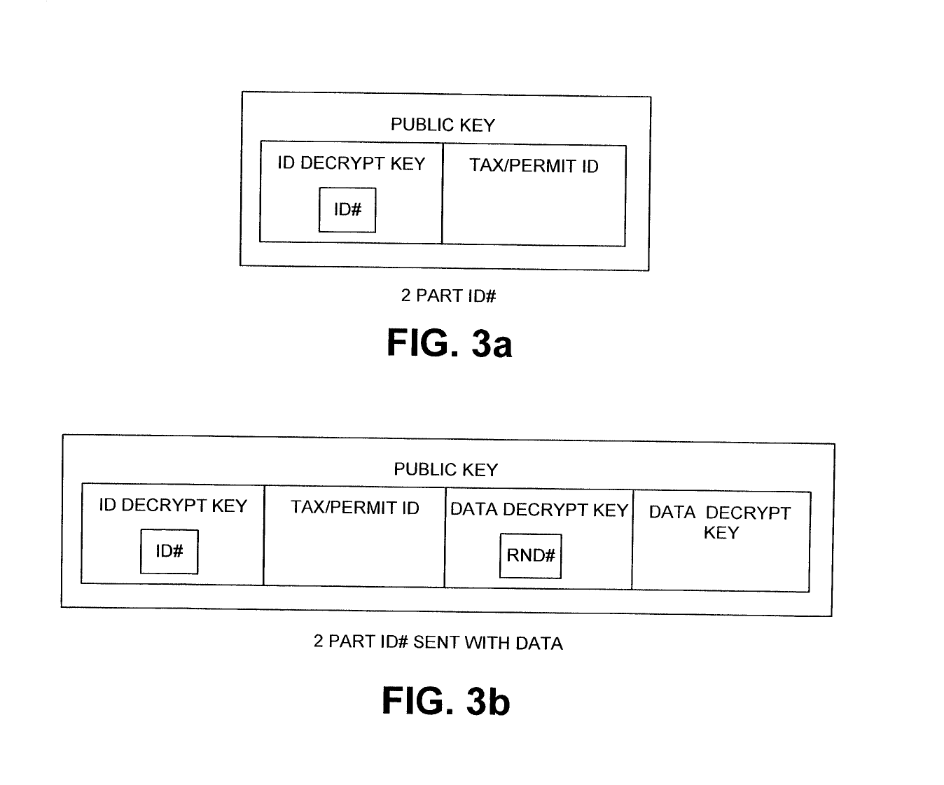

With reference to FIG. 3, the operational and security protocol between the remote and the host device is described.

1. At Enrollment or Initialization

1a) At enrollment, that is first time the host and remote are engaged in use, the HRNG controller 16 generates a random ID#. The ID# is a secret number generated and stored within the secured memory area of the HRNG controller. It is created in order that after initialization, the remote is host specific such that only a specific host device can be used with a specific HRNG controller.

The ID# is never output from the HRNG controller without encryption. Thus, the host device will never know the actual ID# assigned by the HRNG controller.

1b) After creation of the ID#, the ID# is encrypted by the HRNG controller with a randomly generated ID DECRYPT KEY to create an ID#/ID DECRYPT KEY packet (single level encryption).

1c) The ID#/ID DECRYPT KEY packet is then further encrypted by a PUBLIC KEY to create an ID#/ED DECRYPT KEY/PUBLIC KEY packet (double layer encryption) and sent to the host device. The PUBLIC KEY can be set and changed by the HRNG controller or can be set and changed by a system administrator as appropriate (for example, once per day). The PUBLIC KEY is known by both the remote and the host. Accordingly, depending on the location of creation of the PUBLIC KEY, the PUBLIC KEY is forwarded to either the host or remote as required.

1d) The ID#/ID DECRYPT KEY/PUBLIC KEY packet is received by the host. The PUBLIC KEY is used to decrypt the IE)#/ID DECRYPT KEY/PUBLIC KEY packet to the ID#/ID. DECRYPT KEY packet which is subsequently stored in the host device memory.

1e) Enrollment of the remote device with the host is now complete.

2. Data Transaction After Enrollment

The following data transaction protocol is specific to a random number request from a gaming device. It is however understood that a data transaction can be initiated by either the remote device or the host device depending on the specific application and, accordingly, the communication protocol can be readily adapted to the specific directional flow of data.

2a) The host device requests an application specific random number.

2b) Upon receipt of the random number request, the HRNG controller requests the stored ID#/ID DECRYPT KEY packet from the host device and, upon receipt authenticates the ID# with the ID DECRYPT KEY which is only known to the HRNG controller.

If authentication succeeds,

2c) The HRNG controller then generates a RANDOM NUMBER, processes it according to the application format requested by the host and randomly generates a DATA DECRYPT KEY. The DATA DECRYPT KEY is used to create a RANDOM NUMBER/DATA DECRYPT KEY packet.

2d) The HRNG controller then generates a new ED DECRYPT KEY for encryption of the ID#. The ID DECRYPT KEY is used to create a new ID#/ID DECRYPT KEY packet.

2e) The ID#/ID DECRYPT KEY packet, RANDOM NUMBER/DATA DECRYPT KEY packet and the DATA DECRYPT KEY are appended to one another to create an ID#/ID DECRYPT KEY/RANDOM NUMBER/DATA DECRYPT KEY/DATA DECRYPT KEY packet.

2f) The ID#/ID DECRYPT KEY/RANDOM NUMBER/DATA DECRYPT KEY/DATA DECRYPT KEY is encrypted with the PUBLIC KEY to create a ID#/ID DECRYPT KEY/RANDOM NUMBER/DATA DECRYPT KEY/DATA DECRYPT KEY/PUBLIC KEY packet.

2g) The ID#/ID DECRYPT KEY/RANDOM NUMBER/DATA DECRYPT KEY/DATA DECRYPT KEY/PUBLIC KEY packet is sent to the host.

2h) The host device receives the ID#/ID DECRYPT KEY/RANDOM NUMBER/DATA DECRYPT KEY/DATA DECRYPT KEY/PUBLIC KEY packet and using the PUBLIC KEY decrypts the ID#/ID DECRYPT KEY/RANDOM NUMBER/DATA DECRYPT KEY/DATA DECRYPT KEY/PUBLIC KEY packet to the ID#/ID DECRYPT KEY/RANDOM NUMBER/DATA DECRYPT KEY/DATA DECRYPT KEY packet.

2i) The host extracts the RANDOM NUMBER DECRYPT KEY from the ID#/ID DECRYPT KEY/RANDOM NUMBER/DATA DECRYPT KEY/DATA DECRYPT KEY packet. The RANDOM NUMBER DECRYPT KEY is then used to decrypt the RANDOM NUMBER/DATA DECRYPT KEY packet to extract the RANDOM NUMBER for use by the host device.

2j) The ID#/ID DECRYPT KEY packet replaces the ID#/ID# DECRYPT KEY packet previously stored in the host.

2k) Steps 2a-2j are repeated for each random number request received by the HRNG controller.

Notes:

a) The ID DECRYPT KEY is changed and updated with each RANDOM NUMBER request received by the HRNG controller.

b) The PUBLIC KEY is preferably changed either by an authorized administrator or by the HRNG controller on a regular basis as may be appropriate for particular installations.

c) The ID# is never outside the HRNG controller in an unencrypted form.

d) The RANDOM NUMBER DECRYPT KEY is changed with each RANDOM NUMBER request.

e) Once a host device has stored an encrypted ID#, it is no longer possible to enroll another remote to it. Rather, the remote will have detected the presence of some SECRET ID# and should not allow the enrollment to continue.

In another embodiment as shown in FIGS. 3a and 3b and as introduced above, the ID# is a two-part ID number to enable independent auditing of the Dongle/host. In this embodiment, the first part is encrypted by the ID DECRYPT KEY and the second part is legible tax/permit ID information, which is NOT encrypted by the ID DECRYPT KEY. However, the legible tax/permit ID information is encrypted by the PUBLIC KEY whenever sent between the host and the dongle.

In order to ensure that the remote device is stealth, if desired, the delivery of data, is only initiated when the host device sends a request for data. After establishment of the send and receive relationship (handshake) via a handshake protocol, the remote sends the random encryption key. The host device receives and processes the random encryption key in order to decrypt subsequent messages within each frame. This procedure prevents hostile eavesdropping and the possibility of a hacker/thief installing a bogus remote onto the host.

Remote Device 12

The remote operates with separate microcontrollers, a managing controller and the HRNG controller, both of which contain their own set of integrated memories with flash capabilities for in-circuit program download.

HRNG Controller 16

The HRNG controller includes a HRNG 16a and generates and manages random number data for security and for application specific functions.

Managing Controller 18

The managing controller 18 controls the operations between the interface and the HRNG controller 16. The managing controller acts as a data security buffer between the application interface and is programmed to communicate with the HRNG controller 16 on a very private basis. The managing controller is preferably transparent to the specific software implementation of its host device.

Remote and Local Device Interfaces

The interface between the remote and local device may be wired or wireless.

Wired Interface

A wired interface may be a pass-through interface utilizing existing interfaces on a host device such as a simple 2 wire bidirectional interface (I² L, SMBus, Access Bus), an RS232 serial port a parallel port, Ethernet, DSL (Digital Subscriber Line), ADSL (Asymmetric Digital Subscriber Line technology) or POT (Plain Old Telephone, analog telephone).

Preferably, the remote device can connect with the host device between the host and any connected peripheral device without interfering-with the host device's regular use of the interface and without introducing any interference to existing working relationships between the host-device and any peripheral device. Within this context, it is preferred that the remote device has a stealth relationship with the host.

For example, the host-device may have a serial port connected to a modem and a parallel port connected to a printer. A remote device adapted for connection to the host through a serial port can be connected between the host and the modem or a remote device adapted for connection to the host through the parallel port can be connected by a pass through interface. The connection is made in order that the remote device is stealth to the modem, and stealth to the printer allowing regular communication between the host and the peripheral device.

Accordingly, by providing a system which is adaptable to an existing device's serial or parallel port, the functionality of the remote device can be added to the host-device without the need of additional physical ports on the host device thereby increasing the usability and adoption of the system to existing devices.

Wireless Interface

In alternate embodiments of the host device and remote device, communication may be wireless utilizing standard wireless communication hardware/software such as an RF cable plant (i.e., CATV, DIRECTV), IEEE 802.11, or Bluetooth RF.

Both the wired and wireless embodiments can be “inline” or “network” or a combination thereof. Examples of “inline” would include serial, parallel, DSL, ADSL, POT, CATV (i.e., DIRECTV), IEEE 802.11, and Bluetooth RF interfaces and examples of “network” would include RF cable plant (i.e., cable modem), Ethernet, IEEE 802.11, and Bluetooth RF.

Gaming Specific HRNG Controller Overview

In a particular application of the dongle in the gaming industry, the HRNG controller 16 is capable of manufacturing truly random number formats for known games-of-chance including poker, 21, keno, bingo, 8-way slot, 3-reel, 5-reel slots etc. The dongle sends and receives encrypted but simple byte-wide packets using a communications protocol described in greater detail below.

The HRNG microcontroller preferably has a limited number of physical connections (in one embodiment, only five physical connections) to the outside world. In addition, the HRNG controller 16 will preferably have functionality such as hostile intrusion detect with self-destruct (memory) capabilities to thwart hackers including information privileged hackers from gaining access to the secured memory areas of the HRNG microcontroller. The HRNG microcontroller contains hardware cryptographic engines.

Preferably the remote device has the processing bandwidth to produce concurrently several random word formats for each type of game of chance, such that the gaming device host processor can facilitate the simultaneous operation of several types of game of chance.

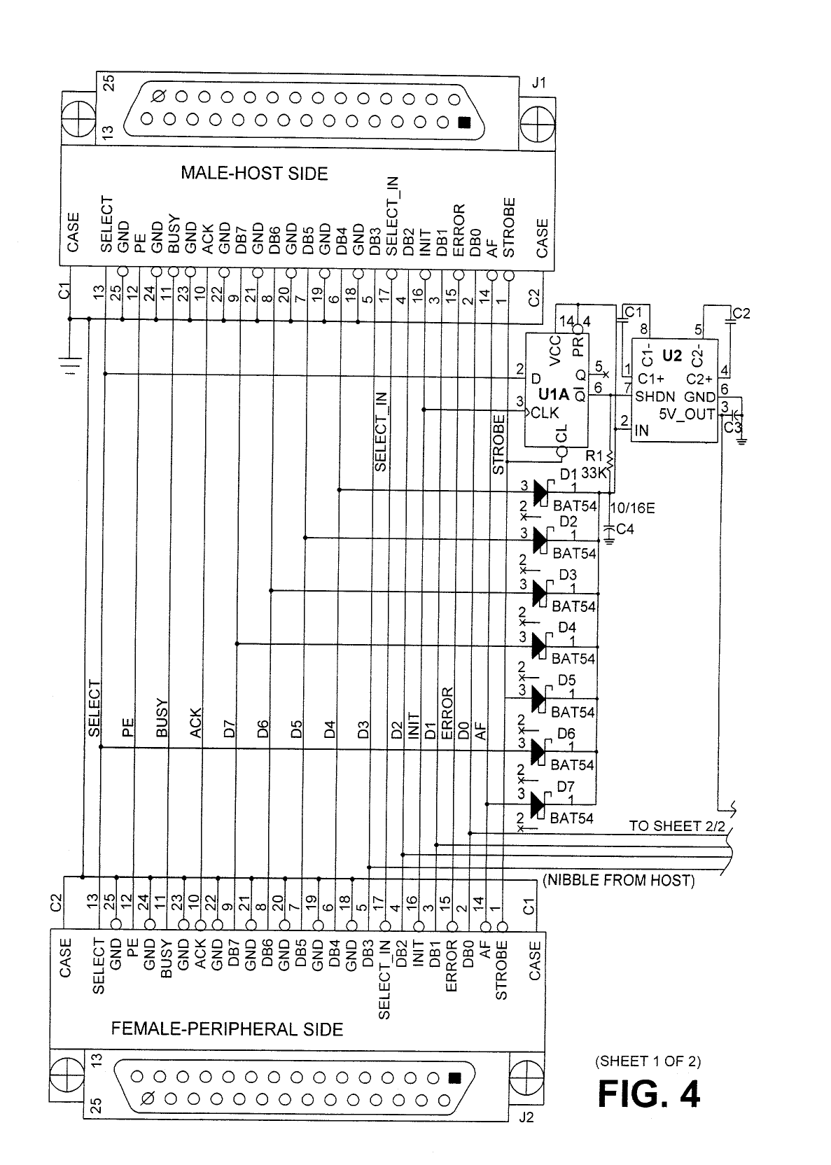

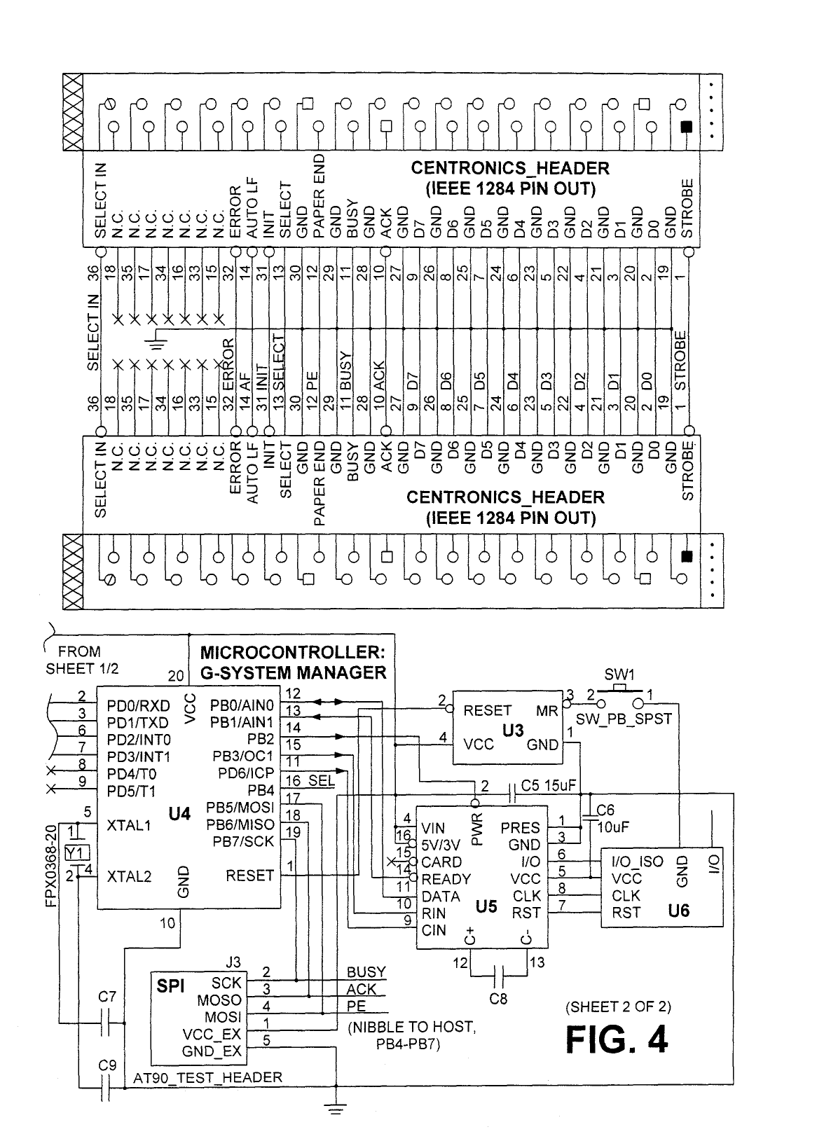

An example of the circuit diagram of a dongle for pass-through attachment to a parallel port is shown in FIG. 4.

Other Features

Power Supply

Power to the remote device can be standalone (battery preferred) or through the host device. The remote may steal power from the host through an existing port or from a separate host power system as would be understood by a worker skilled in the art.

Biometric Identification

In order to enhance the application of the security system in accordance with the invention, additional functionality can be added to the remote to provide user specific security. Biometric identification systems including fingerprint identification, voice identification and facial recognition systems can be implemented within or configurable to the remote device.

Appropriate biometric identification systems can be implement for example by a small 3-wire (cable and jack) connection to communicate with a biometric identification system. In this embodiment, the remote detects the presence of the biometric identification system and will request biometric identification input. If the appropriate biometric information is received, the remote will be activated.

In the specific example of a voice I.D. system, the user is prompted to announce his/her name and/or a four to eight character PIN number. If the voice-print matches the registered user's voice, the remote is activated. A system for enrollment is described in greater detail below.

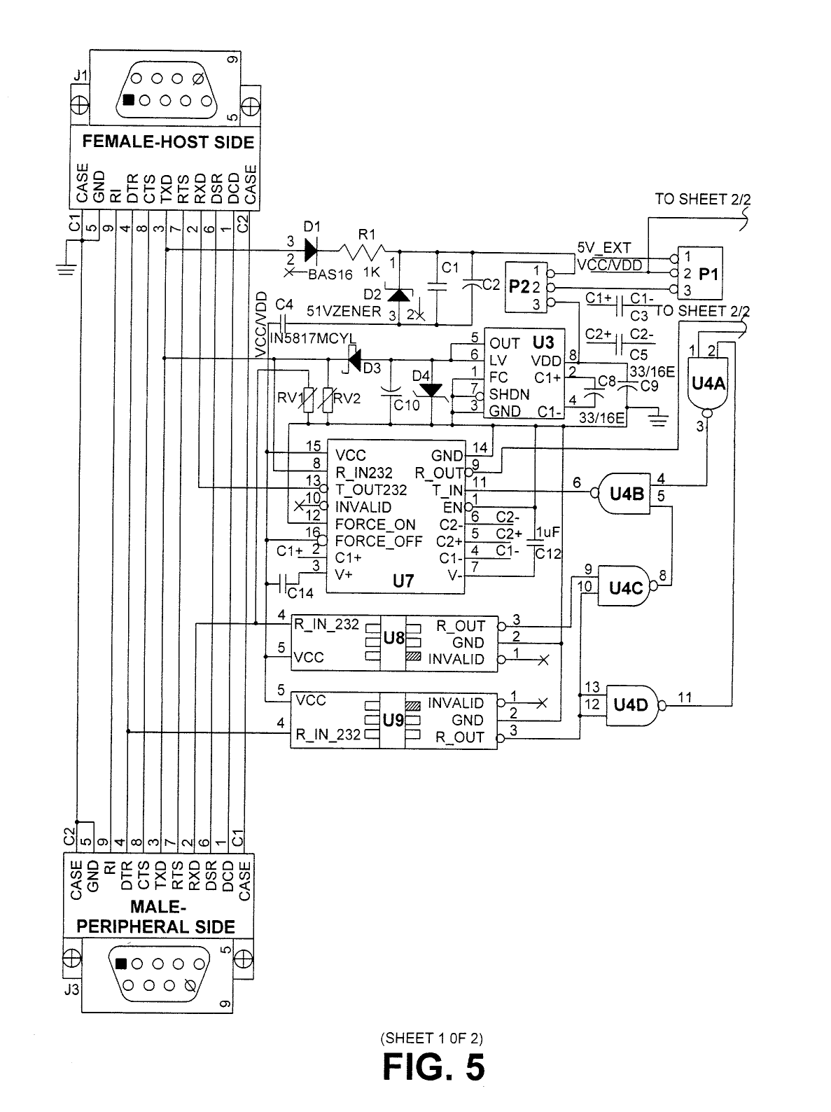

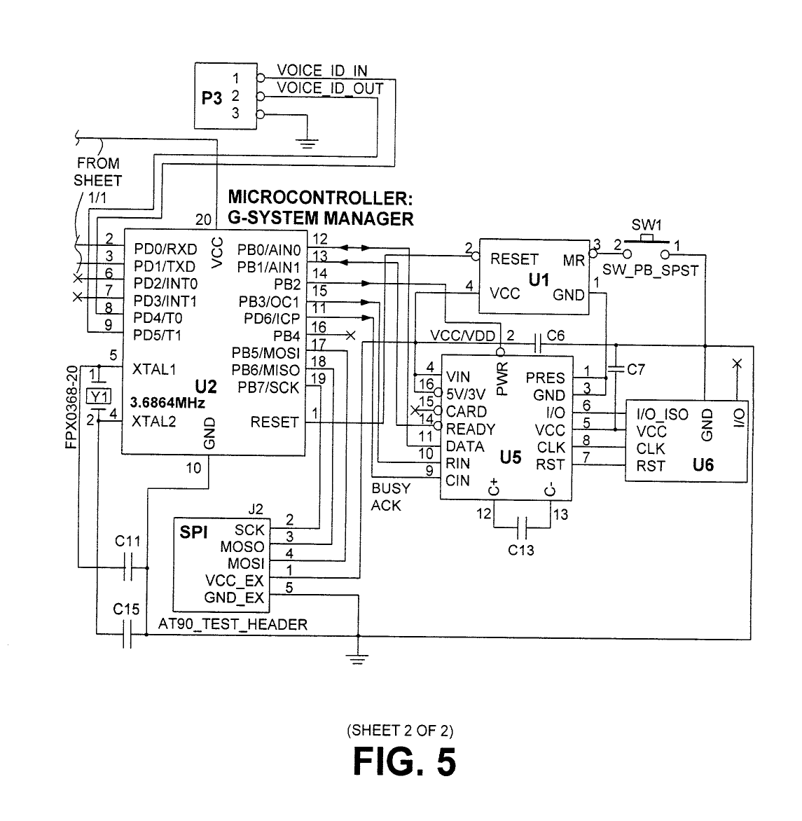

An example of a dongle having biometric voice identification is shown in FIG. 5.

Physical Form

The HRNG controller 16 of the remote device is preferably in the form of a small multi-layered printed circuit board. The remote can also be further integrated and fabricated onto a custom designed application specific integrated circuit (ASIC) chip.

Physical Security

In order to ensure the protection of the device specific ID number, the secured memory area of the remote includes tamper detection. The tamper detection systems will preferably include a combination of physical and electrical property detection devices which will cause the internal flash memory of the remote to be erased if the HRNG controller is violated. The detection systems may include detectors for sensing rapid changes in temperature, electrical resistance, static electricity, power spikes and power failure.

Communication Protocol Example for Gaming Specific Application

The following is an example of a communication protocol between the remote (dongle) and local devices (device) and is specific to a gaming application. It is understood that other communications protocols and command sequences can be implemented in accordance with the invention.

The communication between the HRNG controller and the managing controller is preferably ISO 7816 compliant, via “U5” (FIG. 4) and its is transparent to the host-device. ISO 7816 Standard is built into the HRNG Controller and “U5”. No other external hardware is needed to accomplish this. The security is handled by the secret part of the two-part I.D. number created by the HRNG Controller. The host-device receives the randomly generated encrypted key from the HRNG Controller to decrypt the data packets and for the secret I.D. number verification. The host-device (end user) requests the RNG pursuant to the software Protocol, outlined below from the HRNG controller 16, via its ports, without the need to know the private relationship between the managing controller 18 (U4) and the HRNG controller 16 (U5). The following is a sequence of events:

1. The HRNG Controller fetches the secret encrypted part of the two part I.D. number and checks for its authenticity. The secret I.D. is only known to the HRNG Controller and to no others. It is created once, randomly, during enrollment, but the decryption key is changed for each host-device RNG request.

2. The host-device receives a constantly changing random decryption key from the HRNG Controller for each requested RNG.

3. The HRNG Controller encrypts the secret I.D. number with a new random key at the end of each delivery of RNG to the host-device and will again be fetched for verification when the host-devices requests another RNG.

I. Data Packets

All data transmission is in the form one frame of 8 byte data packets.

Frame 1=Data Packet 0, offset 0

Data Packet 1, offset 1

“

”

Data Packet 7, offset 7

Each data packet begins with a header byte (02H), followed by a command byte, and 4 data bytes. The packet is then terminated with a check sum and a trailer byte (03H).

Data Packet 0, . . . 7=02H, start of text

xxH, Command byte

??H, Data byte 0

??H, Data byte 1

??H, Data byte 2

??H, Data byte 3

yyH, Data Packet check sum

03H, end of text

a) Command Byte

The command byte not only identifies the command but also the source of the packet. The format is as follows:

| | | | | | | | | |
|---|---|---|---|---|---|---|---|---|
| Bit | 7 | 6 | 5 | 4 | 3 | 2 | 1 | 0 |

| | | | |
|---|---|---|---|
| 1 | 0 Device | 00 data | command I.D. |
| 1 | 1 dongle | 01 reserved | command I.D. |
| | | 10 reserved | command I.D. |
| | | 11 reserved | command I.D. |

b) Check Sum

The check sum is computed over the entire packet including the header and trailer bytes. The checksum is calculated as the twos compliment of the sum of all of the packet bytes.

II. ACK

The ack is the only exception to the 8 byte data packets. Both the device and the dongle return a single byte ACK with the value AOH.

III. Data Flow

The device initiates most data transfers. The device will either send data to the dongle or request data from the dongle. A special case is automatic response mode. This is used so the dongle can send data to the device that may require immediate attention. For example dongle status, illegal intrusions, and/or failed self-test. Automatic response mode is enabled or disabled by the device. On power-up the automatic response mode is disabled. If automatic response is disabled the device will need to poll the dongle for status changes.

These modes are outlined below:

1. Send Data (The Handshake and Instruction to Produce Data)

BEGIN

device sends data packet to dongle

dongle receives data packet

IF (no comm error)

BEGIN

dongle returns ACK

dongle executes data packet

(prepare to produce a keno number, etc.)

END

END

The ACK response will be returned within 50 ms. If no ACK is received before 50 ms the device should then re-send the data.

2. Request Data

BEGIN

device sends data request packet to dongle

dongle receives data packet request

IF (no comm error)

BEGIN

dongle sends requested data packet

Device receives data packet

IF (no comm error)

BEGIN

device sends ACK

-OR-

device sends data request packet

-OR-

device sends data packet

END

END

END

The ACK response should be returned within 50 ms. If no ACK is received before 50 ms the dongle will re-send the data until an ACK is received.

3. Automatic Response

BEGIN

dongle condition needs immediate action (ie. Illegal intrusion detected)

IF (automatic response enabled)

BEGIN

dongle sends data packet

device receives data packet

IF (no comm error)

BEGIN

device sends ACK packet

-OR-

device sends data request packet

-OR-

device sends data packet

END

END

END

The ACK response should be returned within 50 ms.

If no ACK is received before 50 ms the dongle will re-send the data until an ACK is received.

4. Communication Error Detection

The protocol also provides communication error detection. An error condition is one of the following:

1) The packet does not begin with the header byte 02H.

2) The packet does not end with the trailer byte 03H.

3) The check sum is not valid.

4) Inter-byte delay greater than 20 ms.

When a data packet is sent from the dongle to the device if it is received without error the device should respond with an ACK. If an error is detected no response is returned to the dongle from the device and the dongle would re-transmit the data until an ACK is received from the device. When a data packet is sent from the device to the dongle if it is received without error the dongle responds with an ACK. If an error is detected no response is returned to the device from the dongle. The device may then elect to re-transmit the data. When a data request is sent from the device to the dongle if it is received without error the dongle responds with the requested data. If an error is detected no response is returned to the device from the dongle. The device would then re-transmit the data request till the data is received. Once the data has been received without error the device would finally respond with an ACK.

IV. Details of the Data Packets Sent from the Device to the Dongle

| | | | |
|---|---|---|---|
| offset | type | value | description |

Request data

| | | | |
|---|---|---|---|
| 0 | byte | 02H | start of text |
| 1 | byte | 80H | command byte |
| 2 | byte | ??H | data to request |
| | | | C0H dongle serial number |
| | | | C1H Version (i.e., I.D. No.) |
| | | | C2H ROM (Flash) check sum |
| | | | C3H EEprom check sum |
| | | | C4H RAM check sum |
| | | | C5H Random Encryption key 0-3 |
| | | | C6H Random Encryption key 4-7 |
| | | | C7H Random Encryption key 8-B |
| | | | C8H Random Encryption key C-F |
| | | | C9H Reserved |
| | | | CAH Reserved |
| | | | CBH Reserved |
| | | | CCH Reserved |
| | | | CDH Reserved |
| | | | CEH Reserved |
| | | | CFH Reserved |
| 3 | byte | ??H | type of Random Word return for C0H |
| | | | 00H auto response status |
| | | | 01H Reshuffle single - deck |
| | | | 02H Send one card from single - deck |
| | | | 03H Reshuffle double - deck |
| | | | 04H Send one card from double - deck |
| | | | 05H Reshuffle 4 card - deck |
| | | | 06H Send one card from 4 card - deck |
| | | | 07H Reshuffle 6 card - deck |
| | | | 08H Send one card from 6 card - deck |
| | | | 09H Restart keno sequence |
| | | | 0AH Send one keno number |
| | | | 0BH Restart Bingo sequence |
| | | | 0CH Send one Bingo number |
| | | | 0DH Slot Reel-Stop range (0-255) |
| | | | 0EH Send Reel-Stop number based on |
| | | | ‘0DH” range |
| | | | 0FH Joker option |
| | | | Example: sending this byte preceding card |
| | | | request, will return a Joker deck. |
| 4 | byte | 00H | reserved |
| 5 | byte | 00H | reserved |
| 6 | byte | ??H | check sum |
| 7 | byte | 03H | end of text |

Automatic response mode

| | | | |
|---|---|---|---|
| 0 | byte | 02H | start of text |
| 1 | byte | 81H | command byte |
| 2 | byte | ??H | automatic response 0 |
| | | | disable |
| | | | 1 enable |
| 3 | byte | 00H | reserved |
| 4 | byte | 00H | reserved |
| 5 | byte | 00H | reserved |
| 6 | byte | ??H | check sum |
| 7 | byte | 03H | end of text |

Misc Output Requests (turn “things” on/off)

| | | | |
|---|---|---|---|
| 0 | byte | 02H | start of text |
| 1 | byte | 82H | command byte |
| 2 | byte | ??H | output states |
| | | | 0 off |
| | | | 1 on |
| | | | bit 0 Reserved |
| | | | bit 1 Reserved |
| | | | bit 2 Reserved |
| | | | bit 3 Reserved |
| | | | bit 4 Reserved |
| | | | bit 5 Reserved |
| | | | bit 6 Reserved |
| | | | bit 7 Reserved |
| 3 | byte | ??H | output states |
| | | | 0 off |
| | | | 1 on |
| | | | bit 0 Reserved |
| | | | bit 1 Reserved |
| | | | bit 2 Reserved |
| | | | bit 3 Reserved |
| | | | bit 4 Reserved |
| | | | bit 5 Reserved |
| | | | bit 6 Reserved |
| | | | bit 7 Reserved |
| 4 | byte | 00H | reserved |
| 5 | byte | 00H | reserved |
| 6 | byte | ??H | check sum |
| 7 | byte | 03H | end of text |

Flash ROM checksum seed

| | | | |
|---|---|---|---|
| 0 | byte | 02H | start of text |
| 1 | byte | 83H | command byte |
| 2 | binary 2 | ????H | checksum seed LSByte first |
| 4 | binary 2 | ????H | checksum divisor LSByte first = |
| | | | 0 igt checksum |
| 6 | byte | ??H | check sum |
| 7 | byte | 03H | end of text |

EEprom checksum seed

| | | | |
|---|---|---|---|
| 0 | byte | 02H | start of text |
| 1 | byte | 84H | command byte |
| 2 | binary 2 | ????H | checksum seed LSByte first |
| 4 | binary 2 | ????H | checksum divisor LSByte first = |
| | | | 0 igt checksum |
| 6 | byte | ??H | check sum |
| 7 | byte | 03H | end of text |

SRAM checksum seed

| | | | |
|---|---|---|---|
| 0 | byte | 02H | start of text |
| 1 | byte | 85H | command byte |
| 2 | binary 2 | ????H | checksum seed LSByte first |
| 4 | binary 2 | ????H | checksum divisor LSByte first = |
| | | | 0 igt checksum |
| 6 | byte | ??H | check sum |
| 7 | byte | 03H | end of text |

Output Single Pulse Commands

| | | | |
|---|---|---|---|
| 0 | byte | 02H | start of text |
| 1 | byte | 86H | command byte |
| 2 | binary 2 | ??H | device number |
| | | | 0 device 1 |
| | | | 1 device 2 |
| | | | 2 device 3 |
| | | | 3 device 4 |
| | | | 4 device 5 |
| | | | 5 device 6 |
| | | | 6 device 7 |
| 3 | byte | 00H | reserved |
| 4 | binary 2 | OOH | reserved |
| 5 | byte | OOH | reserved |
| 6 | byte | ??H | check sum |
| 7 | byte | 03H | end of text |

Random Word Sequence Count

Example: Card No. 14 of 52 card deck

Keno spot 4 of 10

| offset | type | value | description |
|---|---|---|---|
| 0 | byte | 02H | start of text |
| 1 | byte | 87H | command byte |
| 2 | byte | ??H | type of random word/game |
| | | | 0 single (52) card deck |
| | | | 1 Joker card deck |
| | | | 2 2-card deck |
| | | | 3 4-card deck |
| | | | 4 6-card deck |
| | | | 5 keno |
| | | | 6 bingo |
| 3 | binary 2 | ????H | number count LSByte first |
| 5 | byte | OOH | reserved |
| 6 | byte | ??H | check sum |
| 7 | byte | 03H | end of text |

Clear errors

| | | | |
|---|---|---|---|
| 0 | byte | 02H | start of text |
| 1 | byte | 88H | command byte |
| 2 | byte | ??H | error type |
| | | | 0 clear all errors |
| | | | 1 clear communication error |
| | | | 2 invalid CRC |
| | | | 3 Flash ROM check sum |
| | | | 4 Eeprom check sum |
| | | | 5 SRAM check sum |
| | | | 6 reserved |
| | | | 7 reserved |
| | | | FF clear intrusion error |
| 3 | byte | 00H | reserved |
| 4 | byte | 00H | reserved |
| 5 | byte | 00H | reserved |
| 6 | byte | ??H | check sum |
| 7 | byte | 03H | end of text |

Invert Logic

| | | | |
|---|---|---|---|
| 0 | byte | 02H | start of text |
| 1 | byte | 89H | command byte |
| 2 | byte | ??H | inverted logic |
| | | | 0 = standard |
| | | | 1 = invert |
| | | | bit 0 reserved |
| | | | bit 1 reserved |
| | | | bit 2 reserved |
| | | | bit 3 reserved |
| | | | bit 4 reserved |
| | | | bit 5 reserved |
| | | | bit 6 reserved |
| | | | bit 7 reserved |
| 3 | byte | 00H | reserved |
| 4 | byte | 00H | reserved |
| 5 | byte | 00H | reserved |
| 6 | byte | ??H | check sum |
| 7 | byte | 03H | end of text |

Device ACK

A device ACK is sent in response to valid data packet from dongle

| offset | type | value | description |
|---|---|---|---|
| 0 | byte | A0H | command byte |

V. Details of Data Packets Sent from the Dongle to the Device

In automatic response mode packets C0 to C5 are sent automatically when the condition occurs.

dongle status

| offset | type | value | description |
|---|---|---|---|
| 1 | byte | 02H | start of text |
| 1 | byte | C0H | command byte |
| 2 | byte | ??H | status byte |
| | | | 0 all ok |
| | | | 1 check sum completed |
| | | | 2 single card done from single card deck |
| | | | 3 joker card from joker deck done |
| | | | 4 card from 2-card deck done |
| | | | 5 card from 4-card deck done |
| | | | 6 card from 6-card deck done |
| | | | 7 keno number done |
| | | | 8 bingo number done |
| | | | 9 slot reel-stop number done |
| | | | 10 SRAM corruption |
| | | | 11 Flash ROM corruption |
| | | | 12 EEprom corruption |
| | | | 13 intrusion detected |
| | | | 14 reserved |
| | | | 15 reserved |
| | | | 16 reserved |
| | | | 17 reserved |
| | | | 18 reserved |
| | | | 18 reserved |
| | | | 20 reserved |
| | | | 21 reserved |
| 3 | byte | ??H | aux status type |
| | | | 0 no aux status |
| | | | 1 auto response status |
| | | | 2 reserved |
| | | | 3 reserved |
| | | | 4 byte ??H aux status |
| | | | 0 no aux status |
| | | | 0 |
| | | | 1 auto response status |
| | | | 1 enabled |
| | | | 2 reserved |
| | | | 01H reserved bad |
| | | | 02H reserved bad |
| | | | 04H reserved bad |
| | | | 08H reserved bad |
| | | | 10H reserved bad |
| | | | 20H reserved bad |
| | | | 40H reserved bad |
| | | | 3 reserved status |
| | | | 1 reserved failure |
| 5 | byte | 00H | reserved |
| 6 | byte | ??H | checksum |
| 7 | byte | 03H | end of text |

Flash ROM checksum

| | | | |
|---|---|---|---|
| 0 | byte | 02H | start of text |
| 1 | byte | C1H | command byte |
| 2 | binary 2 | ????H | Flash ROM checksum value LSByte first |
| 4 | byte | 00H | reserved |
| 5 | byte | 00H | reserved |
| 6 | byte | ??H | check sum |
| 7 | byte | 03H | end of text |

EEprom checksum

| | | | |
|---|---|---|---|
| 0 | byte | 02H | start of text |
| 1 | byte | 02H | command byte |
| 2 | binary 2 | ????H | EEprom checksum value LSByte first |
| 4 | byte | 00H | reserved |
| 5 | byte | 00H | reserved |
| 6 | byte | ??H | check sum |
| 7 | byte | 03H | end of text |

SRAM checksum

| | | | |
|---|---|---|---|
| 0 | byte | 02H | start of text |
| 1 | byte | C3H | command byte |
| 2 | binary 2 | ????H | SRAM checksum value LSByte first |
| 4 | byte | 00H | reserved |
| 5 | byte | 00H | reserved |
| 6 | byte | ??H | check sum |
| 7 | byte | 03H | end of text |

Reserved

| | | | |
|---|---|---|---|
| 0 | byte | 02H | start of text |
| 1 | byte | C4H | command byte |
| 2 | binary 2 | ??H | SRAM checksum value LSByte first |
| 3 | byte | ??H | reserved |
| 4 | byte | ??H | reserved |
| 5 | byte | 00H | reserved |
| 6 | byte | ??H | check sum |
| 7 | byte | 03H | end of text |

Reserved I/O

| | | | |
|---|---|---|---|
| 0 | byte | 02H | start of text |
| 1 | byte | C5H | command byte |
| 2 | byte | ??H | I/O state 1 |
| | | | 0 unchanged |
| | | | 1 changed |
| | | | bit 0 reserved |
| | | | bit 1 reserved |
| | | | bit 2 reserved |
| | | | bit 3 reserved |
| | | | bit 4 reserved |
| | | | bit 5 reserved |
| | | | bit 6 reserved |
| | | | bit 7 reserved |
| 3 | byte | ??H | I/O state 2 |
| | | | 0 unchanged |
| | | | 1 changed |
| | | | bit 0 reserved |
| | | | bit 1 reserved |
| | | | bit 2 reserved |
| | | | bit 3 reserved |
| | | | bit 4 reserved |
| | | | bit 5 reserved |
| | | | bit 6 reserved |
| | | | bit 7 reserved |
| 4 | byte | ??H | I/O state 3 |
| | | | 0 unchanged |
| | | | 1 changed |
| | | | bit 0 reserved |
| | | | bit 1 reserved |
| | | | bit 2 reserved |
| | | | bit 3 reserved |
| | | | bit 4 reserved |
| | | | bit 5 reserved |
| | | | bit 6 reserved |
| | | | bit 7 reserved |
| 5 | byte | ??H | I/O state 4 |
| | | | 0 unchanged |
| | | | 1 changed |
| | | | bit 0 reserved |
| | | | bit 1 reserved |
| | | | bit 2 reserved |
| | | | bit 3 reserved |
| | | | bit 4 reserved |
| | | | bit 5 reserved |
| | | | bit 6 reserved |
| | | | bit 7 reserved |
| 6 | byte | ??H | checksum |
| 7 | byte | 03H | end of text |

Reserved state

| | | | |
|---|---|---|---|
| 0 | byte | 02H | start of text |
| 1 | byte | C6H | command byte |
| 2 | byte | ??H | state 1 |
| | | | 0 (close) |
| | | | 1 (open) |
| | | | bit 0 reserved |
| | | | bit 1 reserved |
| | | | bit 2 reserved |
| | | | bit 3 reserved |
| | | | bit 4 reserved |
| | | | bit 5 reserved |
| | | | bit 6 reserved |
| | | | bit 7 reserved |
| 3 | byte | ??H | state 2 |
| | | | 0 (close) |
| | | | 1 (open) |
| | | | bit 0 reserved |
| | | | bit 1 reserved |
| | | | bit 2 reserved |
| | | | bit 3 reserved |
| | | | bit 4 reserved |
| | | | bit 5 reserved |
| | | | bit 6 reserved |
| | | | bit 7 reserved |
| 4 | byte | ??H | state 3 |
| | | | 0 (close) |
| | | | 1 (open) |
| | | | bit 0 reserved |
| | | | bit 1 reserved |
| | | | bit 2 reserved |
| | | | bit 3 reserved |
| | | | bit 4 reserved |
| | | | bit 5 reserved |
| | | | bit 6 reserved |
| | | | bit 7 reserved |
| 5 | byte | 00H | reserved |
| 6 | byte | ??H | check sum |
| 7 | byte | 03H | end of text |

Reserved I/O output

| | | | |
|---|---|---|---|
| 0 | byte | 02H | start of text |
| 1 | byte | C7H | command byte |
| 2 | binary 2 | ????H | Value LSByte first |
| 4 | byte | ??H | I/O mode |
| | | | 0 OFF |
| | | | 1 ON |
| 5 | byte | ??H | I/O installed installed |
| | | | 0 not installed |
| | | | 1 installed |
| 6 | byte | ??H | check sum |
| 7 | byte | 03H | end of text |

Reserved I/O status

| | | | |
|---|---|---|---|
| 0 | byte | 02H | start of text |
| 1 | byte | C8H | command byte |
| 2 | binary 2 | ????H | I/O status value LSByte first |
| 4 | byte | ??H | I/O mode |
| | | | 0 OFF |
| | | | 1 ON |
| 5 | byte | ??H | I/O installed |
| | | | 0 not installed |
| | | | 1 installed |
| 6 | byte | ??H | check sum |
| 7 | byte | 03H | end of text |
| Version | | | |
| 0 | byte | 02H | start of text |
| 1 | byte | C9H | command byte |
| 2 | byte | ??H | month code (BCD) |
| 3 | byte | ??H | day code (BCD) |
| 4 | byte | ??H | year code (BCD) |
| 5 | byte | ??H | seq number (binary) |
| 6 | byte | ??H | check sum |
| 7 | byte | 03H | end of text |

Random key data bytes 1-4

| | | | |
|---|---|---|---|
| 0 | byte | 02H | start of text |
| 1 | byte | CAH | command byte |
| 2 | byte | ??H | data byte 1 |
| 3 | byte | ??H | data byte 2 |
| 4 | byte | ??H | data byte 3 |
| 5 | byte | ??H | data byte 4 |
| 6 | byte | ??H | check sum |
| 7 | byte | 03H | end of text |

Random key data bytes 5-8

| | | | |
|---|---|---|---|
| 0 | byte | 02H | start of text |
| 1 | byte | CBH | command byte |
| 2 | byte | ??H | data byte 5 |
| 3 | byte | ??H | data byte 6 |
| 4 | byte | ??H | data byte 7 |
| 5 | byte | ??H | data byte 8 |
| 6 | byte | ??H | check sum |
| 7 | byte | 03H | end of text |

Password bytes 1-4

| | | | |
|---|---|---|---|
| 0 | byte | 02H | start of text |
| 1 | byte | CCH | command byte |
| 2 | byte | ??H | data byte 1 |
| 3 | byte | ??H | data byte 2 |
| 4 | byte | ??H | data byte 3 |
| 5 | byte | ??H | data byte 4 |
| 6 | byte | ??H | check sum |
| 7 | byte | 03H | end of text |

Password bytes 5-8

| | | | |
|---|---|---|---|
| 0 | byte | 02H | start of text |
| 1 | byte | CDH | command byte |
| 2 | byte | ??H | data byte 5 |
| 3 | byte | ??H | data byte 6 |
| 4 | byte | ??H | data byte 7 |
| 5 | byte | ??H | data byte 8 |
| 6 | byte | ??H | check sum |
| 7 | byte | 03H | end of text |

Secure data bytes 1-4

| | | | |
|---|---|---|---|
| 0 | byte | 02H | start of text |
| 1 | byte | CEH | command byte |
| 2 | byte | ??H | data byte 9 |
| 3 | byte | ??H | data byte 10 |
| 4 | byte | ??H | data byte 11 |
| 5 | byte | ??H | data byte 12 |
| 6 | byte | ??H | check sum |
| 7 | byte | 03H | end of text |

Secure data bytes 5-8

| | | | |
|---|---|---|---|
| 0 | byte | 02H | start of text |
| 1 | byte | CFH | command byte |
| 2 | byte | ??H | data byte 13 |
| 3 | byte | ??H | data byte 14 |
| 4 | byte | ??H | data byte 15 |
| 5 | byte | ??H | data byte 16 |
| 6 | byte | ??H | check sum |
| 7 | byte | 03H | end of text |

dongle Device ACK (sent in response to valid data packet from device)

offset type value description

0 byte AOH command byte

### GAMING APPLICATION EXAMPLES

### Example 1

In a card game using a 52 card deck, the host system requests a card out of the deck. The HRNG controller captures a set of random streaming bits and constructs a deck of cards and manages the distribution of the deck, as requested by the host system. If the card game requires multiple decks, the HRNG controller constructs the decks to be supplied to the host system on demand.

### Example 2

A keno game using 80 numbers. The host system requests a keno number and the HRNG captures a set of random streaming bits and constructs an 80 number set and manages its distribution as requested by the host system.

Authorization System Using Biometric ID

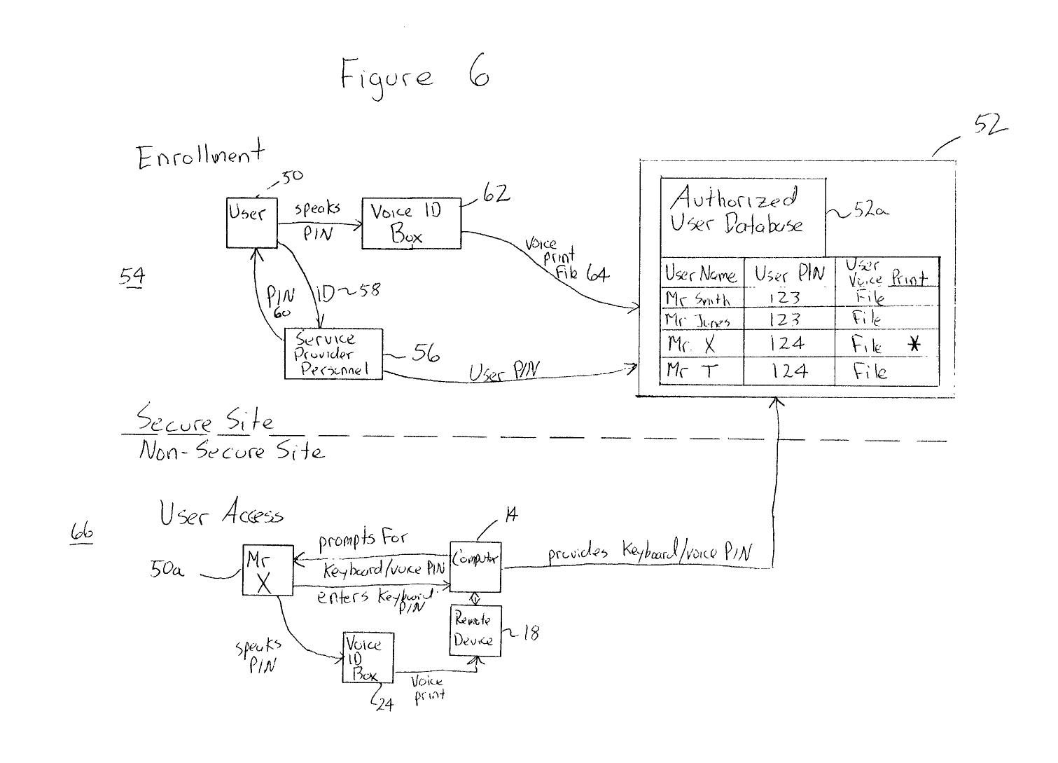

In accordance with another embodiment of the invention as shown in FIG. 6, a system and methodology is provided for verifying the identity of a user wishing to access a service provider's secure system. Examples of such a system would be an internet or non-supervised gaming site or location where the age of a user is of legal importance for the operation of the site and/or a financial institution's website involving personal financial data.

In order to access such a secure system, enrollment may proceed as follows:

1. A potential user 50 wishing to enroll with a service provider 52 would make a physical appearance at an enrollment centre 54 or secure location where service provider personnel 56 would verify the identification and qualifications of the potential user by checking conventional identification 58 including photo ID and other legitimate ID such as a driver's license, passport etc.

2. After the service provider personnel was satisfied that the potential user is a legitimate is H consumer, the user 50 would be given a numeric and/or letter (character) personal identification number (PIN) 60 of typically four to eight digits or letters, and would be asked to speak that PIN into a voice ID box 62 to create a secure-location voice print file 64. In different embodiments of the system, it may be required that the user remember their PIN or alternatively be issued with a card having the PIN character details visually or electronically encoded on the card. In an embodiment where the PIN is electronically encoded, the card may be inserted into a card reader operatively connected (described below) to the remote device to provide the character PIN information to the service provider during authorization.

3. The user's name, character PIN and secure-location voice print file is entered into the service provider's authorized user's database 52a.

4. After enrollment, the user 50a can access the service's providers site 52 from a non-secure site 66 having a host device 14 with internet access, a remote device 18 as described above and a voice ID box 24.

5. After gaining preliminary access to the service provider's secure site 52, the user 50a would be prompted to enter their character PIN (either by a keyboard or card reader) and speak their voice print PIN into the voice ID box 24. By providing both a character PIN and voice print PIN, the authorized user database 52a is able to verify the identity of the user 50a more quickly by initially identifying each of the authorized users having the same PIN and then determining their true identity by a comparison of the voice print on file (secure location voice print) and the newly spoken PIN. In this manner, an authorized user registered in the authorized user database containing many thousands of users can be identified more quickly than identifying the user strictly on the basis of their voiceprint as the subset of files being searched is smaller. That is, this system mininizes the complexity of the number of numbers required to form the PIN, the test PIN serves as a sort and search index for the corresponding voiceprint file.

The accuracy of the voice print verification software is able to distinguish between a truly spoken PIN and a PIN which may have been recorded on a recording machine and played back by an unauthorized user.

In certain service provider applications, the system will prompt the user to re-speak their PIN periodically throughout a transaction to ensure the actual user is the authorized user.

In a further embodiment, the enrollment stage as described above may require a declaration or “soft” affidavit at either a secure or non-secure site by the potential user where the user states that they meet the legal or selection requirements for access to the service provider's site. In this embodiment, the user may contact the service provider's site to enroll and be presented with a legal declaration document acknowledging that they meet the legal criteria for enrollment, such as age and/or the absence of any barring criteria including a previous expulsion order from that site. While it is recognized that this form of enrollment is not as secure as a secure-site enrollment described above, for certain applications or services, it is sufficient.

Upon making the declaration, the user would be asked to biometrically enroll with the system as outlined above.

Card Reader

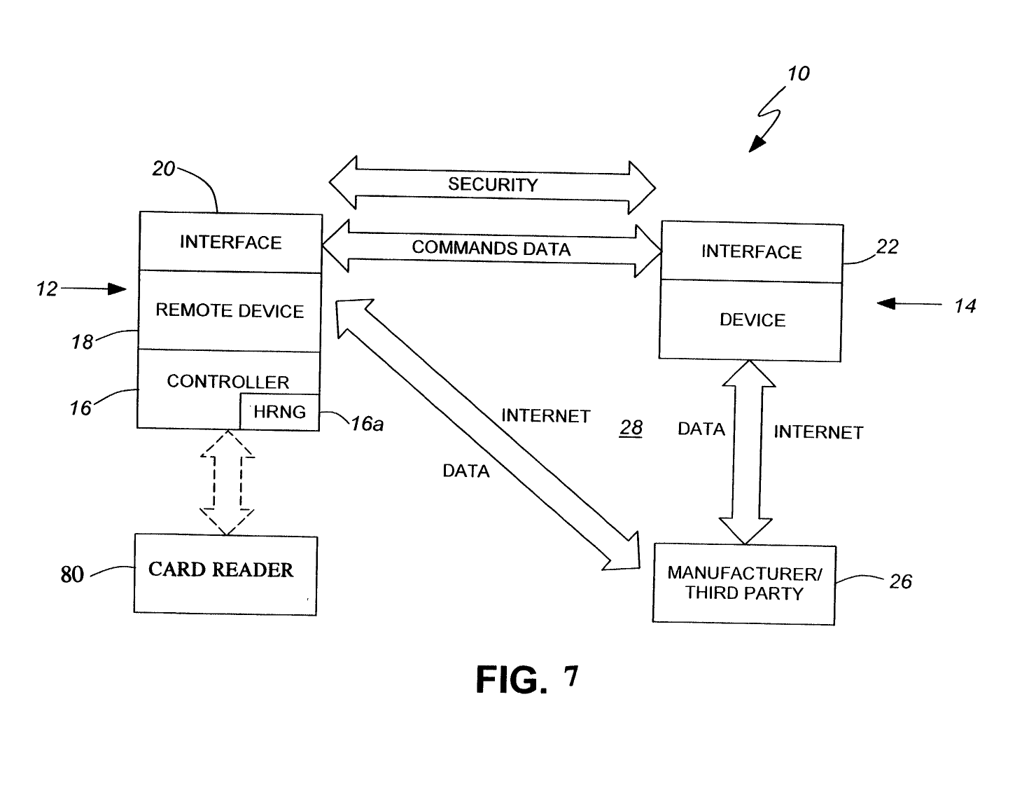

In a further embodiment, the remote device includes a card reader 80 as shown in FIG. 7, the card reader enabling data such as user identification information, debit, credit or smart card data to be accessed through the device 12.

Point to Point Communications

In further applications of the security system, secure transactions between different local computers is provided. That is, in a system where each computer has its own remote device 90, 192, an initiation protocol would establish basic contact between each computer in which encrypted secret ID#'s would be exchanged between devices. Upon receiving an encrypted secret ID#, each computer would recognize the existence of a secure environment allowing the respective users to further select the level of encryption for any subsequent transaction. That is, each user could select single or double levels of encryption (potentially higher) for a transaction as controlled by a randomly changing public key as described above.

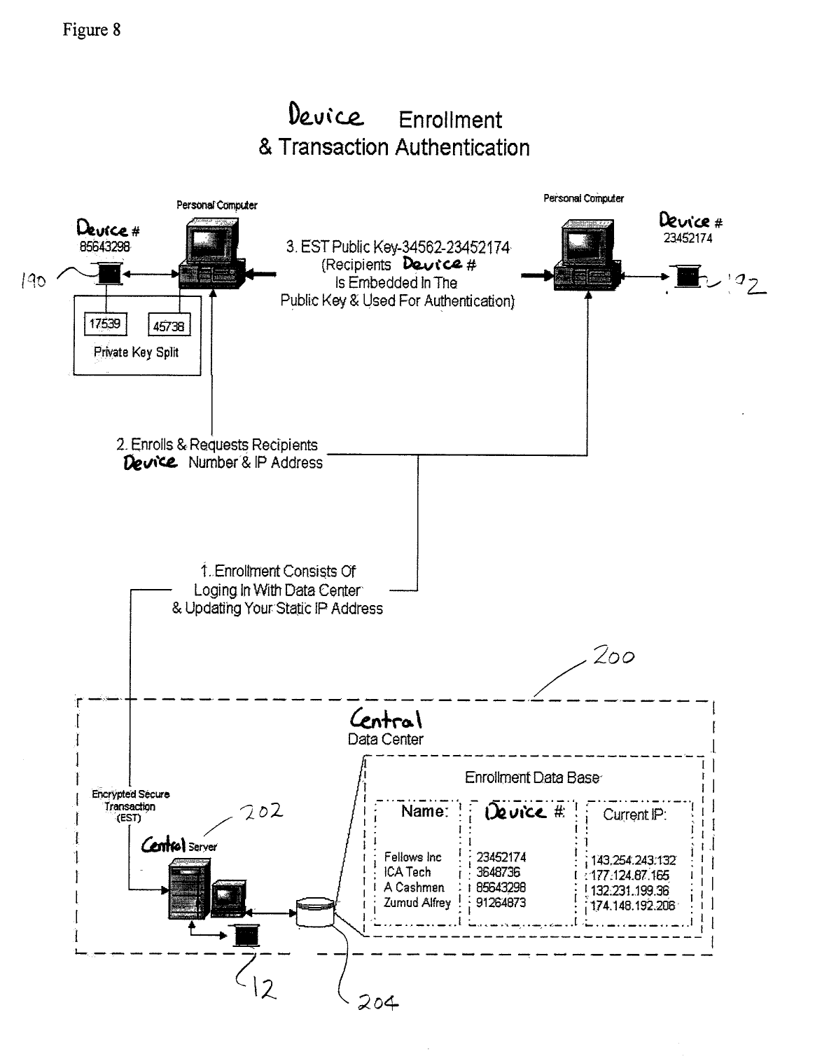

Still further and with reference to FIG. 8, a system is also provided in which a central site is used to enroll respective remote devices 190, 192. The central site includes a central server 202 with remote device 12 and enrollment database 204. The enrollment database 204 contains device specific information including names, device #'s and current IP addresses. At enrollment, a user (at device 190 or 192) logs into the central server 202 and provides an encrypted ID# to the central server 202 which is stored in the enrollment database along with the user IP address and other identifiers.

If the user having device 190 wishes to initiate a transaction with the user having device 192, the user 190 requests 192's device number and IP address from the enrollment database 204. If the enrollment information is available, that is if user 192 has enrolled, both users are notified that both devices are enrolled, thereby enabling further transactions using a randomly changing public key as described above.

1. A system for securing data transactions between a remote device and a host device, the remote device comprising:
an interface adapted for operative connection between the host device and the remote device;
a managing controller operatively connected to the interface, the managing controller for controlling data transactions between the remote device and host device; and,
a hardware random number generator (HRNG) controller operatively connected to the managing controller for providing non-deterministic random number data for data encryption to the managing controller.

2. A system as in claim 1 wherein the HRNG controller includes an HRNG for providing streaming random number bits and the HRNG controller formats the random number bits to at least one predetermined byte format.

3. A system as in claim 1 wherein the HRNG controller includes a secured memory area.

4. A system as in claim 3 wherein the HRNG controller generates an ID number for storage in the secured memory area.

5. A system as in claim 4 wherein the ID number is encrypted to a first level with an ID decrypt key.

6. A system as in claim 5 wherein the encrypted ID number is encrypted to a second level with a public key for enrollment of the remote device with the host device.

7. A system as in claim 5 wherein the host device uses the public key to decrypt the ID number to the single level and the host device stores the first level encryption ID number.

8. A system as in claim 6 wherein the public key is changed by a system administrator.

9. A system as in claim 6 wherein after enrollment, the HRNG controller verifies the validity of the first level encryption ID number prior to an exchange of application specific data between the host and remote device.

10. A system as in claim 9 wherein upon verification of the first level encryption ID number, the HRNG controller creates a data decrypt key for encrypting application specific data to a first data encryption level.

11. A system as in claim 10 wherein the HRNG controller creates a new ID decrypt key for encrypting the ID number to a first level.

12. A system as in claim 11 wherein the application specific data encrypted to a first data encryption level and the ID number encrypted to a first level and the data decrypt key are appended to one another to form an appended data packet.

13. A system as in claim 12 wherein the appended data packet is encrypted with the public key.

14. A system as in claim 1 wherein the interface is a pass-through interface.

15. A system as in claim 1 wherein the interface is wireless.

16. A system as in claim 1 wherein the at least one pre-determined format includes at least one game-of -chance format.

17. A system as in claim 1 wherein the HRNG controller has physical and electrical intrusion detection and internal memory self-destruction responsive to physical or electrical intrusion.

18. A system as in claim 1 further comprising a biometric identification system operatively connected to the remote device.

19. A system as in claim 18 wherein the biometric identification system is selected from any one of or a combination of a voice recognition, facial recognition or finger print recognition system.

20. A system as in claim 1 wherein the remote device is stealth with respect to the host device.

21. A dongle for controlling and managing data communications between a host device and the dongle, comprising:
an interface adapted for operative connection between the host device and the dongle;
a managing controller operatively connected to the interface, the managing controller for receiving and providing data to and from the host device and for receiving and providing data to and from a hardware random number generator controller operatively connected to the managing controller, the HRNG controller for providing non-deterministic random number data to the managing controller.

22. A dongle as in claim 21 wherein the HRNG controller includes an HRNG for providing streaming random number bits and the HRNG controller formats the random number bits to at least one predetermined byte format.

23. A dongle as in claim 21 wherein the HRNG controller includes a secured memory area.

24. A dongle as in claim 23 wherein the HRNG controller generates an ID number for storage in the secured memory area.

25. A dongle as in claim 24 wherein the HRNG controller encrypts the ID number to a first level with an ID decrypt key.

26. A dongle as in claim 25 wherein the HRNG controller encrypts the encrypted ID number to a second level with a public key during enrollment of the remote device with the host device.

27. A dongle as in claim 26 wherein after enrollment, the HRNG controller verifies the validity of the first level encryption ID number prior to an exchange of application specific data between the host and remote device.

28. A dongle as in claim 27 wherein upon verification of the first level encryption ID number, the HRNG controller creates a data decrypt key for encrypting application specific data to a first data encryption level.

29. A dongle as in claim 25 wherein the HRNG controller creates a new ID decrypt key for encrypting the ID number to a first level for each exchange of application specific data.

30. A dongle as in claim 28 wherein the application specific data encrypted to a first data encryption level and the ID number encrypted to a first level and the data decrypt key are appended to one another to form an appended data packet.

31. A dongle as in claim 30 wherein the appended data packet is encrypted with the public key.

32. A dongle as in claim 21 wherein the interface is a pass-through interface.

33. A dongle as in claim 21 wherein the interface is wireless.

34. A dongle as in claim 21 wherein the at least one pre-determined format includes at least one game-of -chance format.

35. A dongle as in claim 21 wherein the HRNG controller has physical and electrical intrusion detection and internal memory self-destruction responsive to physical or electrical intrusion.

36. A dongle as in claim 21 further comprising a biometric identification system operatively connected to the remote device.

37. A dongle as in claim 36 wherein the biometric identification system is selected from any one of or a combination of a voice recognition, facial recognition or finger print recognition system.

38. A dongle as in claim 21 wherein the dongle is stealth with respect to the host device.

39. A method of enrolling a specific remote device with a host device comprising the steps of:
a. generating and storing a non-deterministic ID number in the remote device;
b. encrypting the ID number to a first level with a non-deterministic ID decrypt key;
c. encrypting the first level encrypted ID number to a second level with a public key;
d. passing the second level encrypted ID number to the host device;
e. decrypting the second level encrypted ID number in the host device with the public key to the first level and storing the first level encrypted ID number in the host device.

40. A method of verifying the enrollment of a specific remote device with a host device comprising the steps of:
a. requesting a first level encrypted non-deterministic ID number from the host device by the remote device;
b. receiving and decrypting the first level encrypted non-deterministic ID number with a previously generated and stored non-deterministic ID decrypt key; and,
c. verifying equivalency between the decrypted non-deterministic ID number of step b) with a previously generated and stored non-deterministic ID number in the remote device.

41. A method of transferring data between a remote device previously enrolled with a host device comprising the steps of:
a. encrypting a data packet with a non-deterministic data decrypt key;
b. encrypting an ID number with a non-deterministic ID decrypt key;
c. appending the encrypted data packet of step a) to the encrypted ID number of step b) with the ID decrypt key of step b) to form an encrypted data packet;
d. encrypting the encrypted data packet of step c) with a public key to form a second level encrypted data packet;
e. passing the second level encrypted data packet to the host device; and,
f. decrypting the second level encrypted data packet of step e) with the public key and data decrypt key to retrieve the data packet.

42. A method as in claim 41 wherein the encrypted ID number of step b) updates a previously stored encrypted ID number in the host device.

43. A system for enrolling a user with a service provider to allow access to the service provider from a non-secure location comprising the steps of:
at a secure or non-secure location for enrolling the user,
a) providing a user with a character personal identification number (PIN);
b) providing a user with a voice PIN;
c) having a user speak the voice PIN into a voiceprint processor to create a secure-location voice print file of the voice PIN;
d) storing the character PIN and voice print file in an authorized user database.

44. A system as in claim 43 further comprising the steps of:
at a non-secure location having a computer and a second voice print processor operatively connected to the authorized user database,
a) prompting a user to enter the character PIN;
b) prompting a user to enter the voice PIN into the second voice print processor to create a non-secure location voice print file;
c) submitting the character PIN and non-secure location voice print file to the authorized user database; and,
at the authorized user database
d) searching the character PIN in the authorized user database for similar character PINs; and
e) searching the non-secure location voice print file against the voice print files of record for similar character PINs to determine if the non-secure location voice print file corresponds to a voice print file of record.

45. A system as in claim 44 further comprising the step of notifying the user if they are an authorized or unauthorized user.

46. A system as in claim 45 further comprising the step of periodically requesting re-entry of the character PIN and voice PIN for re-authorization if the user is an authorized user to and has gained access to the service provider's services.

47. A system as in claim 43 wherein at enrollment and prior to step a), the user declares if they meet specific enrollment criteria for accessing the service provider.

48. A method for enrolling and securing transactions between host devices each having a dongle as in claim 21 and a central enrollment database comprising the steps of:
a. enrolling an encrypted ID# within the dongle with the central enrollment database; and,
b. verifying each host device has completed the enrollment of step a) prior to permitting a public key encrypted transaction between the host devices.
